(19) United States
(12) Patent Application Publication
(10) Pub. No.: US 2010/0022293 A1
(43) Pub. Date: Jan. 28, 2010

(54) SYSTEM AND METHOD FOR PRODUCING JACKPOT

(76) Inventor: Jae-Hyung Lee, Daejeon (KR)

Correspondence Address: ZARLEY LAW FIRM P.L.C., CAPITAL SQUARE, 400 LOCUST, SUITE 200, DES MOINES, IA, 50309-2350, US

(21) Appl. No.: 12/257,000

(22) Filed: Oct. 23, 2008

(30) Foreign Application Priority Data
Jul. 28, 2008 (KR) 10-2008-0073583

(51) Int. Cl. A63F 9/24; A63F 13/00

(52) U.S. Cl. 463/20

(57) ABSTRACT

Disclosed is a system and method for producing a jackpot. The system includes at least one reel game controlling device generating winning specifications corresponding to re2el arrangement formed during progress of a reel game and a jackpot managing unit for providing a subject reel game controlling device with a jackpot event, the subject reel game controlling device being designated by drawing among the reel game controlling devices through reflecting the winning specification on probability calculation or randomly calculating probability, wherein the subject reel game controlling device executes the jackpot game based on the jackpot event and notifies a gamer of a jackpot prize according to whether an execution result of the game satisfies a predetermined winning condition of a jackpot. Therefore, the gamer comes to expect the jackpot during playing the reel game so as to feel novel enjoyment of the reel game.

### BACKGROUND OF THE INVENTION

1. Field of the Invention

The present invention relates to a reel game control, and more particularly to a system and a method for producing a jackpot in which a jackpot game is provided to a reel game controlling device generating the winning specification lower than a reference and displayed on an arbitrary portion of a screen during the reel game being executed, or a jackpot game is randomly provided to a reel game controlling device so that a gamer can feel novel enjoyment of the reel game.

2. Description of the Prior Art

Conventionally, a reel game machine, such as a slot machine, or the like, is classified into a mechanical reel game machine for directly displaying round reels on a screen through a display in accordance with compulsorily rotating and interrupting the round reel having a plurality of symbols arranged in a line through a driving motor, and an electronic reel game machine for displaying the reels having a plurality of programmed symbols with a random number on a display screen, such as a monitor, or the like.

However, in such a reel game machine, if a symbol arrangement of the reels is satisfied with a winning condition, the gamer can feel enjoyment of receiving a winning score corresponding to the winning condition, but a game method is simple so that the gamer easily loses interest in the game.

In order to solve the problem and allow the gamer to enjoy the game without losing interest, the winning condition has been diversified with varying the number of reels and the symbols.

However, even if the winning condition is diversified and the reel game is progressed, if the winning specification generated during the spent time period is less than the expectation, the gamers cannot much enjoy the game.

Therefore, a solution is in demand to solve the aforementioned problem.

### SUMMARY OF THE INVENTION

Therefore, the present invention has been made in view of the above-mentioned problems, and an object of the present invention is to provide a system and a method for producing a jackpot in which a jackpot game is provided to a reel game controlling device generating the winning specification lower than a reference and displayed on an arbitrary portion of a screen during the reel game being executed or a jackpot game is randomly provided to a reel game controlling device so that a gamer can feel novel enjoyment of the reel game.

In accordance with an aspect of the present invention, there is provided a system for producing a jackpot, including: at least one reel game controlling device generating winning specifications corresponding to reel arrangement formed during progress of a reel game; and a jackpot managing unit for providing a subject reel game controlling device with a jackpot event, the subject reel game controlling device being designated by drawing among the reel game controlling devices through reflecting the winning specification on probability calculation or randomly calculating probability, wherein the subject reel game controlling device executes the jackpot game based on the jackpot event and notifies a gamer of a jackpot prize according to whether an execution result of the game satisfies a predetermined winning condition of a jackpot.

Preferably, the system further includes a network connecting unit for communication connecting the reel game controlling devices and the jackpot managing unit.

Preferably, if the jackpot managing unit reflects the winning specification on the probability calculation and draws the subject reel game controlling device, the jackpot managing unit gives a lottery additional score to a reel game controlling device generating the winning specification lower than a predetermined level among the reel game controlling devices so as to calculate the probability.

Preferably, the jackpot managing unit designates one or more subject reel game controlling devices.

Preferably, in a case where a plurality of subject reel game controlling devices is designated, if at least two subject reel game controlling devices are satisfied with the winning condition of the jackpot, the jackpot managing unit gives the corresponding jackpot prize to one subject reel game controlling device which is first satisfied with the winning condition, or divides and gives the jackpot prize.

Preferably, the jackpot managing unit classifies the winning condition of the jackpot according to a difficulty level so as to set at least one winning condition of the jackpot, and differently set the jackpot prize according to the difficulty level.

Preferably, in the jackpot game, a predetermined number of symbols is displayed on a screen of a terminal of the subject reel game controlling device and a character or an image corresponding to a button input or touch input of a user with respect to each symbol among the predetermined number of symbols is displayed so as to generate an execution result of the game.

In accordance with another aspect of the present invention, there is provided a reel game controlling device, including: a display unit for displaying reel arrangement generated during progress of a reel game; a controlling unit for generating winning specification corresponding to the reel arrangement; a user interface unit for receiving a button input or touch input for generating the reel arrangement; and a network interface unit for communication connecting to an external network, wherein the controlling unit executes the jackpot game based on a jackpot event provided from the external network according to drawing through reflecting the winning specification on probability calculation or randomly calculating the probability, and notifies a user of a corresponding jackpot prize according to whether an execution result of the game satisfies a predetermined winning condition of the jackpot.

Preferably, the controlling unit completes the reel game and then executes the jackpot game.

In accordance with another aspect of the present invention, there is provided a method for producing a jackpot, including the steps of: collecting a winning specification of receiving the winning specification generated according to reel arrangement formed during progress of a reel game in at least one reel game controlling device; designating a subject reel game controlling device in which the subject reel game controlling device is designated by drawing from at least one reel game controlling device through reflecting the winning specification on probability calculation or randomly calculating the probability and then a jackpot event is provided to the subject reel game controlling device; executing the jackpot game of executing the jackpot game based on the jackpot event provided from the subject reel game controlling device and receiving an execution result of the game; and notifying a winning result of notifying a corresponding jackpot prize according to whether the execution result of the game satisfies a predetermined winning condition of the jackpot via the subject reel game controlling device.

Preferably, in the step of designating the subject reel game controlling device, if the subject reel game controlling device is drawn through reflecting the winning specification on the probability calculation, a lottery additional score is given to a reel game controlling device generating the winning specification lower than a predetermined level among the reel game controlling devices so as to calculate the probability.

Preferably, in the step of executing the jackpot game, the subject reel game controlling device displays a predetermined number of symbols on a screen of a terminal, displays a character or an image corresponding to a button input or touch input of the user with respect to each symbol among the predetermined number of symbols, and generates the execution result of the game.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating a system for producing a jackpot according to an exemplary embodiment of the present invention;

FIG. 2 is a diagram illustrating a reel game controlling device of FIG. 1;

FIGS. 3A to 3C are example views illustrating a jackpot game executed by the reel game controlling device of FIG. 1; and

FIG. 4 is a flowchart illustrating a step of an operation of the system for producing a jackpot of FIG. 1.

### DETAILED DESCRIPTION OF THE EXEMPLARY EMBODIMENTS

Hereinafter, preferred embodiments of a system for producing a jackpot according to the present invention will be described in detail with reference to the accompanying drawings.

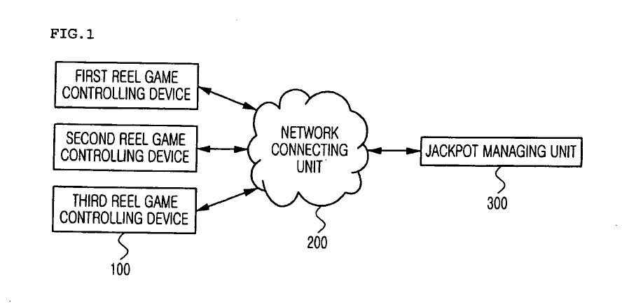

FIG. 1 is a diagram illustrating a system for producing a jackpot according to an exemplary embodiment of the present invention. Referring to FIG. 1, the system for producing the jackpot includes at least one reel game controlling device 100 generating a winning specification corresponding to a symbol arrangement according to reel arrangement formed during the progress of the reel game, and a jackpot managing unit 200 reflecting a predetermined portion of the winning specification provided from the reel game controlling device 100 for calculating probability so as to provide a jackpot event to the reel game controlling device generating less winning specifications or providing the jackpot event to the reel game controlling device designated according to randomly calculating probability.

It is preferred that the system for producing the jackpot further includes a network connecting unit for communication connecting the reel game controlling device 100 and the jackpot managing unit 200.

The system for producing the jackpot can be implemented in such a manner that the reel game controlling devices 100 and the jackpot managing unit 200 are positioned at an identical area and connected with each other via the network, or where the reel game controlling devices 100 diversely positioned on a plurality of areas are connected with the jackpot managing unit 200 via the network.

Here, the reel game controlling device 100 receiving the jackpot event becomes the subject reel game controlling device 100.

The subject reel game controlling device 100 executes the jackpot game based on the jackpot event, generates an execution result of the game by a button input or touch input of a user for the executed jackpot game, and transmits the generated execution result of the game to the jackpot managing unit 200.

Then, the jackpot managing unit 200 identifies if the execution result of the game is satisfied with a predetermined winning condition of the jackpot, and if the execution result of the game is a winner according to the identification result, the jackpot managing unit 200 transmits a jackpot prize corresponding to the winning result to the subject reel game controlling device 100 so as to notify the user of the jackpot prize.

The jackpot game is implemented in such a manner that a predetermined number of symbols is displayed on a screen of a terminal of the subject reel game controlling device 100, the user executes the button input or touch input for each of the displayed symbols, and a character or an image hidden in each symbol is displayed, so that the execution result of the game is generated.

If a plurality of subject reel game controlling devices is designated, it can be implemented in such a manner that if at least two subject reel game controlling devices 100 are satisfied with the winning condition of the jackpot, the jackpot managing unit 200 gives the corresponding jackpot prize to the subject reel game controlling device first satisfying the winning condition, or the jackpot managing unit 200 equally divides the jackpot prize and gives the equally divided jackpot prize to the subject reel game controlling devices 100. In this case, the jackpot prize can be variously managed.

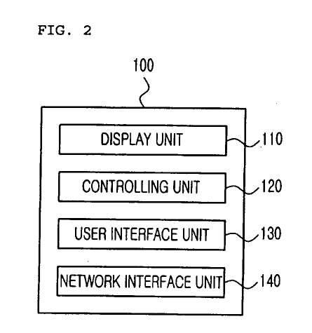

FIG. 2 is a diagram illustrating the reel game controlling device 100 of FIG. 1. Referring to FIG. 2, the reel game controlling device 100 includes a display unit 110 for displaying the arrangement of the reels generated during the progress of the reel game, a controlling unit 120 for generating the winning specification corresponding to the arrangement of the reels, a user interface unit 130 for receiving the button input or touch input for generating the arrangement of the reels, and a network interface unit 140 for communication connecting to an external network.

The controlling unit 120 is connected with the jackpot managing unit 200 via the network interface unit 140, receives the jackpot event provided from the subject reel game controlling device 100 designated by the jackpot managing unit 200, and executes the jackpot game based on the received jackpot event.

Further, the controlling unit 120 transmits the execution result of the jackpot game to the jackpot managing unit 200, identifies the winning of the jackpot, and if there is the jackpot prize corresponding to the result, notifies the user of the jackpot prize through the display unit 110.

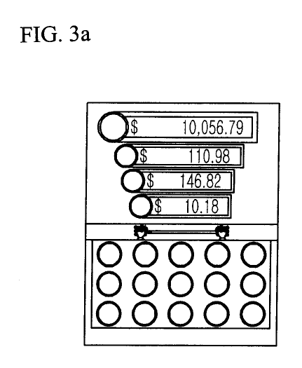

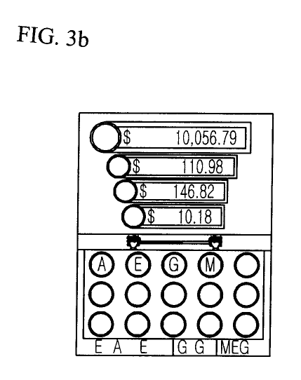

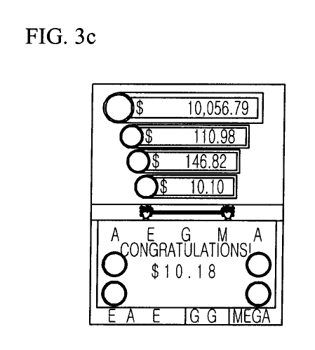

FIGS. 3A to 3C are example views illustrating the jackpot game executed by the subject reel game controlling device of FIG. 1. Referring to FIGS. 3A to 3C, the subject reel game controlling device finishes the reel game, responds to the provided jackpot event, and shifts to the jackpot game (FIG. 3A).

In this jackpot game, the predetermined number of symbols is displayed on a lower portion of the display and the jackpot prize according to the degree of difficulty of the jackpot winning condition is notified on an upper portion of the display.

Then, the user executes the button input or touch input for each symbol, the character or image hidden in the symbol is displayed, and the execution result of the game is generated (FIG. 3B).

The subject reel game controlling device 100 identifies if the execution result of the game is satisfied with the predetermined jackpot winning condition (e.g. if a character, ‘AEGMA’, is finally displayed, the jackpot of $10.10 is hit.) and notifies the user of the result (FIG. 3C).

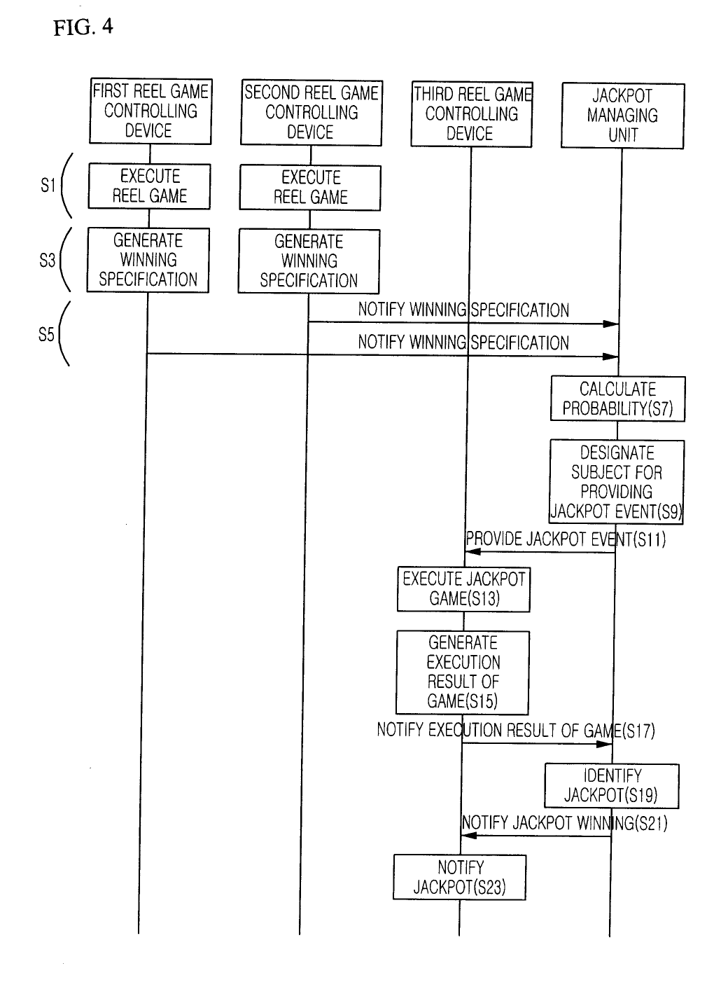

FIG. 4 is a flowchart illustrating a step of an operation of the system for producing a jackpot of FIG. 1. Referring to FIG. 4, according to the method for producing the jackpot, at least one reel game controlling device (e.g. a first reel game controlling device, a second reel game controlling device, and a third reel game controlling device) executes the reel game, respectively, and generates the corresponding winning specification S1 and S3.

Then, the first reel game controlling device and second reel game controlling device generating the winning specification transmit each winning specification to the jackpot managing unit 200 S5.

The jackpot managing unit 200 gives a lottery additional score to the third reel game controlling device 100 in which the winning specification is generated lower than the predetermined level, and calculates the probability for discriminating a subject for providing the jackpot event S7.

In step S7, if the third reel game controlling device 100 is designated as the subject reel game controlling device S9, the jackpot managing unit 200 provides the jackpot event to the third reel game controlling device 100 S11.

Then, the third reel game controlling device 100 executes the jackpot game based on the received jackpot event so as to generate the execution result of the game corresponding to the input of the user S13 and S15.

Such a generated execution result of the game is transmitted to the jackpot managing unit 200 S17, the jackpot managing unit 200 identifies if the execution result of the game is satisfied with the predetermined winning condition of the jackpot and transmits the result to the third reel game controlling device 100 S19 and S21.

If the execution result corresponds to the jackpot winning, the third reel game controlling device 100 displays the result of the jackpot winning and notifies the user of the game of the result S23.

Accordingly, the system and method for producing the jackpot according to the present invention have an advantage in that the jackpot game is provided to the reel game controlling device generating the winning specification lower than the reference, and displayed on the arbitrary portion of the screen during the reel game being executed or the jackpot game is randomly provided to a reel game controlling device so that a gamer can feel novel enjoyment of the reel game.

Although an exemplary embodiment of the present invention has been described for illustrative purposes, those skilled in the art will appreciate that various modifications, additions and substitutions are possible, without departing from the scope and spirit of the invention as disclosed in the accompanying claims.

Further, because the present invention provides the system and method for producing the jackpot in which the jackpot game is provided to the reel game controlling device generating the winning specification lower than the reference, and displayed on the arbitrary portion of the screen during the reel game being executed, or the jackpot game is randomly provided to a reel game controlling device so that a gamer can feel novel enjoyment of the reel game, the present invention not only has sufficient marketability and possibility for sale, but also can be sufficiently implemented in actuality, so that the present invention is industrially applicable.

What is claimed is:

1. A system for producing a jackpot, comprising:
at least one reel game controlling device generating winning specifications corresponding to reel arrangement formed during progress of a reel game; and
a jackpot managing unit for providing a subject reel game controlling device with a jackpot event, the subject reel game controlling device being designated by drawing among the reel game controlling devices through reflecting the winning specification on probability calculation or randomly calculating probability,
wherein the subject reel game controlling device executes the jackpot game based on the jackpot event and notifies a gamer of a jackpot prize according to whether an execution result of the game satisfies a predetermined winning condition of a jackpot.

2. The system as claimed in claim 1, further comprising a network connecting unit for communication connecting the reel game controlling devices and the jackpot managing unit.

3. The system as claimed in claim 1, wherein, if the jackpot managing unit reflects the winning specification on the probability calculation and draws the subject reel game controlling device, the jackpot managing unit gives a lottery additional score to a reel game controlling device generating the winning specification lower than a predetermined level among the reel game controlling devices so as to calculate the probability.

4. The system as claimed in claim 1, wherein the jackpot managing unit designates one or more subject reel game controlling devices.

5. The system as claimed in claim 4, wherein, in a case where a plurality of subject reel game controlling devices is designated, if at least two subject reel game controlling devices are satisfied with the winning condition of the jackpot, the jackpot managing unit gives the corresponding jackpot prize to one subject reel game controlling device which is first satisfied with the winning condition, or divides and gives the jackpot prize.

6. The system as claimed in claim 1, wherein the jackpot managing unit classifies the winning condition of the jackpot according to a difficulty level so as to set at least one winning condition of the jackpot, and differently set the jackpot prize according to the difficulty level.

7. The system as claimed in claim 1, wherein, in the jackpot game, a predetermined number of symbols is displayed on a screen of a terminal of the subject reel game controlling device and a character or an image corresponding to a button input or touch input of a user with respect to each symbol among the predetermined number of symbols is displayed so as to generate an execution result of the game.

8. A reel game controlling device, comprising:
a display unit for displaying reel arrangement generated during progress of a reel game;
a controlling unit for generating winning specification corresponding to the reel arrangement;
a user interface unit for receiving a button input or touch input for generating the reel arrangement; and
a network interface unit for communication connecting to an external network,
wherein the controlling unit executes the jackpot game based on a jackpot event provided from the external network according to drawing through reflecting the winning specification on probability calculation or randomly calculating the probability, and notifies a user of a corresponding jackpot prize according to whether an execution result of the game satisfies a predetermined winning condition of the jackpot.

9. The reel game controlling device as claimed in claim 8, wherein the controlling unit completes the reel game and then executes the jackpot game.

10. A method for producing a jackpot, comprising the steps of:
collecting a winning specification of receiving the winning specification generated according to reel arrangement formed during progress of a reel game in at least one reel game controlling device;
designating a subject reel game controlling device in which the subject reel game controlling device is designated by drawing from at least one reel game controlling device through reflecting the winning specification on probability calculation or randomly calculating the probability and then a jackpot event is provided to the subject reel game controlling device;
executing the jackpot game of executing the jackpot game based on the jackpot event provided from the subject reel game controlling device and receiving an execution result of the game; and
notifying a winning result of notifying a corresponding jackpot prize according to whether the execution result of the game satisfies a predetermined winning condition of the jackpot via the subject reel game controlling device.

11. The method as claimed in claim 10, wherein, in the step of designating the subject reel game controlling device, if the subject reel game controlling device is drawn through reflecting the winning specification on the probability calculation, a lottery additional score is given to a reel game controlling device generating the winning specification lower than a predetermined level among the reel game controlling devices so as to calculate the probability.

12. The method as claimed in claim 10, wherein, in the step of executing the jackpot game, the subject reel game controlling device displays a predetermined number of symbols on a screen of a terminal, displays a character or an image corresponding to a button input or touch input of the user with respect to each symbol among the predetermined number of symbols, and generates the execution result of the game.
